(19) United States
(12) Patent Application Publication
(10) Pub. No.: US 2025/0202024 A1
(43) Pub. Date: Jun. 19, 2025

(54) TRACTION BATTERY PACK HEADER ASSEMBLY

(71) Applicant: Ford Global Technologies, LLC, Dearborn, MI (US)

(72) Inventors: Mohammadreza Eftekhari, Novi, MI (US); Sambhu Prasad Bommisetty, Canton, MI (US); Kanchana Perumalla, Troy, MI (US); Ahalya Srikanth, Lasalle (CA); Eric Poirier, Brownstown, MI (US); Joseph O'Connor, Holly, MI (US)

(21) Appl. No.: 18/544,026

(22) Filed: Dec. 18, 2023

(51) Int. Cl. H01M 50/296; B60L 50/60; H01M 50/204; H01M 50/224; H01M 50/262

(52) U.S. Cl. CPC H01M 50/296; H01M 50/204; H01M 50/224; H01M 50/262; B60L 50/60; H01M 2220/20

(57) ABSTRACT

A battery pack assembly includes a header base of a header assembly. The header base is connectable to a battery pack enclosure. The header assembly further includes a grounding link that is contained within the header base. The grounding link establishes a ground path between the battery pack enclosure and one or more vehicle connectors that are coupled to the header assembly.

### TECHNICAL FIELD

This disclosure relates generally to a header assembly for a traction battery pack and, more particularly, to a header assembly incorporating a grounding link.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A battery pack can power the electric machines. The battery pack of an electrified vehicle can include groups of battery cells.

### SUMMARY

In some aspects, the techniques described herein relate to a battery pack assembly, including: a header base of a header assembly, the header base connectable to a battery pack enclosure; and a grounding link of the header assembly, the grounding link contained within the header base, the grounding link establishing a ground path between the battery pack enclosure and one or more vehicle connectors that are coupled to the header assembly.

In some aspects, the techniques described herein relate to a battery pack assembly, wherein the header base is a dielectric.

In some aspects, the techniques described herein relate to a battery pack assembly, wherein the header base is a polymer-based material.

In some aspects, the techniques described herein relate to a battery pack assembly, wherein the grounding link is more conductive than the header base.

In some aspects, the techniques described herein relate to a battery pack assembly, wherein the grounding link is a metal or metal alloy.

In some aspects, the techniques described herein relate to a battery pack assembly, further including a plurality of mechanical fasteners that secure the header base to the battery pack enclosure.

In some aspects, the techniques described herein relate to a battery pack assembly, wherein a portion of the grounding link is sandwiched between the battery pack enclosure and the header base.

In some aspects, the techniques described herein relate to a battery pack assembly, wherein the battery pack enclosure includes a tray, the header base connectable to the tray.

In some aspects, the techniques described herein relate to a battery pack assembly, wherein the tray is a metal or metal alloy.

In some aspects, the techniques described herein relate to a battery pack assembly, wherein the header assembly includes a plurality of header connectors each having a header housing and at least one electrical terminal, the header connectors each configured to couple to one of the vehicle connectors.

In some aspects, the techniques described herein relate to a battery pack assembly, wherein the header housings for the header connectors and the header base are separate components.

In some aspects, the techniques described herein relate to a battery pack assembly, wherein the header base includes a plurality of apertures and the grounding link includes a plurality of halos, each halo within the plurality of halos circumscribing one of the apertures within the plurality of apertures, the header connectors each spanning over one of apertures within the plurality of apertures.

In some aspects, the techniques described herein relate to a battery pack assembly, wherein the grounding link includes a plurality of legs each extending from one of the halos within the plurality of halos to the battery pack enclosure when the header base is connected to the battery pack enclosure.

In some aspects, the techniques described herein relate to a battery pack assembly wherein a plurality of mechanical fasteners secure the plurality of header connectors to the header base.

In some aspects, the techniques described herein relate to a battery pack assembly, wherein the header housings for the header connectors and the header base are parts of the same structure.

In some aspects, the techniques described herein relate to a battery pack assembly, further including, the battery pack enclosure, and a battery array held within an interior area of the battery pack enclosure.

In some aspects, the techniques described herein relate to a battery pack connection method, including: securing a header base of a header assembly to a battery pack enclosure such that the header base is disposed over an opening in the battery pack enclosure and sandwiches a portion of a grounding link against the battery pack enclosure, the grounding link establishing a ground path between the battery pack enclosure and one or more vehicle connectors that are coupled to the header assembly.

In some aspects, the techniques described herein relate to a battery pack connection method, further including securing the header base to the battery pack enclosure using at least one mechanical fastener.

In some aspects, the techniques described herein relate to a battery pack connection method, further including securing a plurality of header connectors to the header base, each of the header connectors each having a header housing and at least one electrical terminal, the grounding link electrically coupled to the at least one electrical terminal.

In some aspects, the techniques described herein relate to a battery pack connection method, further including coupling the one or more vehicle connectors to the header connectors to electrically couple a vehicle to the battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective view of the traction battery pack from the electrified vehicle of FIG. 1.

FIG. 3 illustrates a closeup view of a header assembly from the traction battery pack of FIG. 2.

FIG. 4 illustrates a perspective expanded view of the header assembly of FIG. 2.

FIG. 5 illustrates a back side of the header assembly when connected to an enclosure of the battery pack with the enclosure shown in broken lines.

### DETAILED DESCRIPTION

A header assembly can provide one or more interfaces for connecting connectors to a battery pack. This disclosure details example exemplary headers that include a grounding link within a polymer-based base. In the past, header connectors have been made of made of a highly conductive material, such as aluminum.

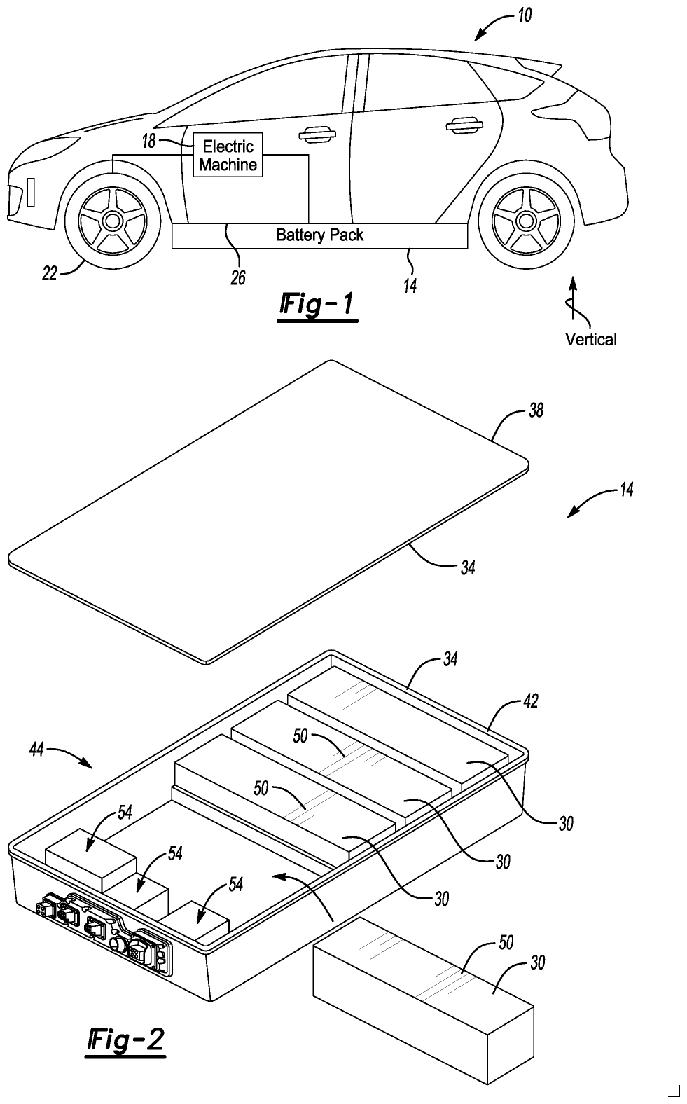

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 can be a relatively high-voltage battery.

The battery pack 14 is, in the exemplary embodiment, secured and grounded to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the plurality of battery arrays 30. The enclosure cover 38, the enclosure tray 42, or both, can be a metal or metal alloy such as

The battery arrays 30 each includes a plurality of battery cells 50 (or simply, “cells”) stacked side-by side relative to each other. The battery cells 50 are for supplying electrical power to various components of the electrified vehicle 10.

Although a specific number of cells 50 and arrays 30 are illustrated in the various figures of this disclosure, the battery pack 14 could include any number of arrays 30 having any number of cells 50. In other words, this disclosure is not limited to the specific configuration shown in FIG. 2.

Other components 54 are housed within the enclosure assembly 34. Examples of the other components 54 can include control modules. In particular, the other components housed within the enclosure assembly 34 can include a Bussed Electrical Center (BEC), a Battery Electronic Control Module (BECM), and a Battery Pack Sensor Module (BPSM).

The battery pack 14 includes a header assembly 58 that provides multiple connection interfaces for connectors to couple to the traction battery pack 14. The connection interfaces can connect to vehicle connectors to send power outside the battery pack 14, to communicate information to and from the battery pack 14, to power components within the battery pack 14, or some combination of these.

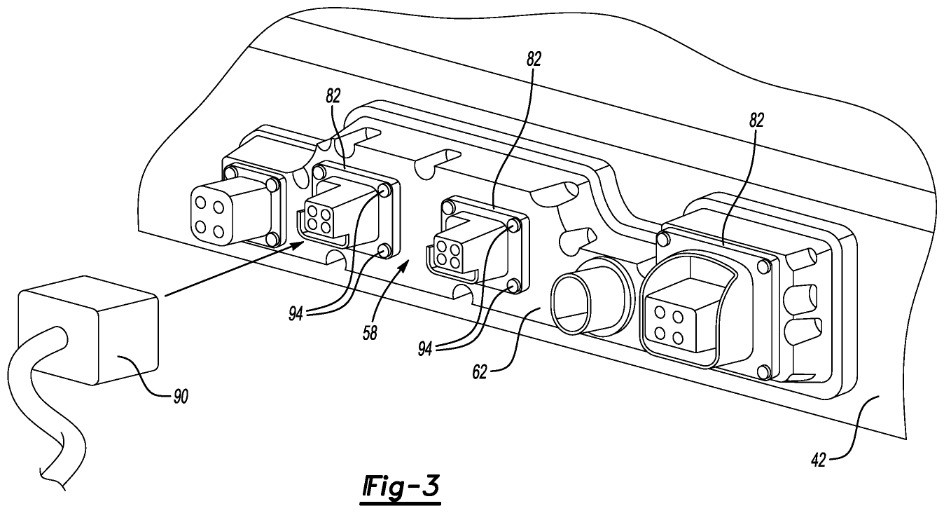

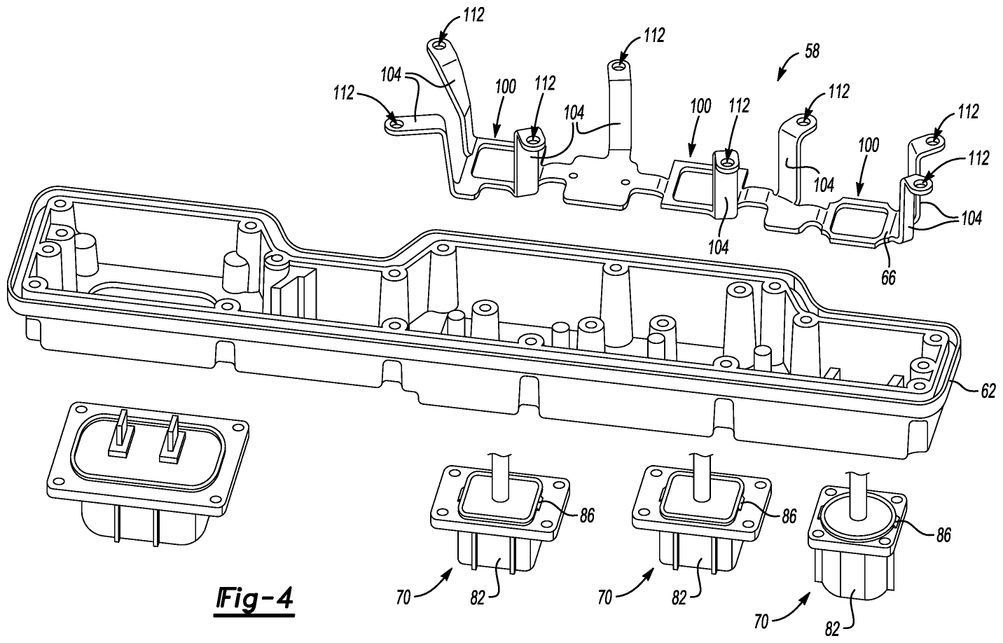

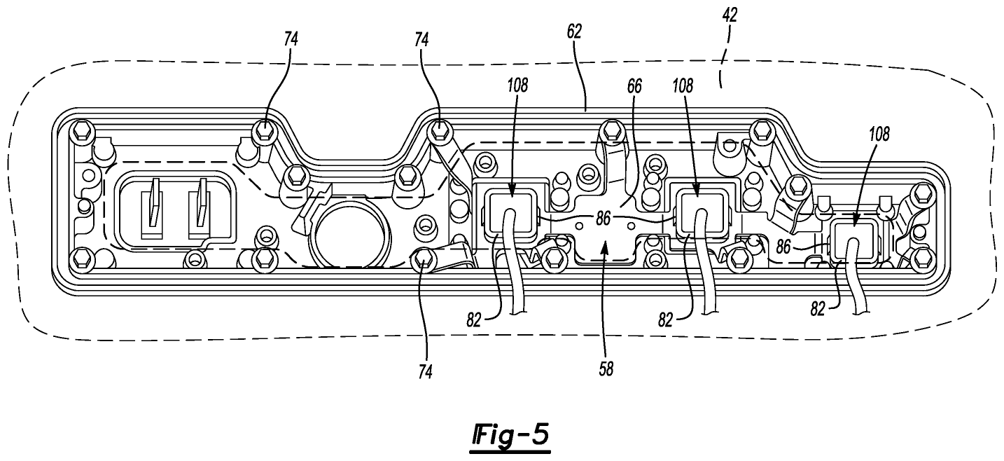

With reference now to FIGS. 3-5 and continuing reference to FIGS. 1 and 2, in this example, the header assembly 58 includes a header base 62, a grounding link 66, and at least one header connector 70. The header assembly 58 is secured to the enclosure assembly 34 and is disposed over an opening in the enclosure assembly 34.

A plurality of mechanical fasteners 74 secure the example header assembly 58 to an outer surface of the enclosure tray 42. The fasteners 74 extend through the enclosure tray 42 to threadably engage the header base 62.

The header connectors 70 in this example each include a housing 82 and at least one terminal 86. The header connectors 70 each provides an interfaces for connecting a vehicle connector 90 to the header assembly 58. Power, signals, or both can flow to and from the battery pack 14 through the connection between the header connector 70 and the vehicle connector 90 when the vehicle connector 90 is operably connected to the one of the header connectors 70. The housing 82 can be a polymer-based material, such as Polyphenylene Sulfide (PPS), Nylon 66 (Polyamide, PA 66), PolyButylene Terephthalate (PBT), PolyPropylene (PP), PolyCarbonate (PC), Nylon 12 (Polyamide, PA 12), or Cross Linked PolyOlefin (XLPO). The terminal 86 can be a metal or metal-alloy.

The terminals 86 within the header connectors 70 can be pins that are received with corresponding sockets provided by terminals in the vehicle connector 90. The terminals 86 can instead be sockets that receive pins in the vehicle connector 90.

The header base 62 is a polymer-based material, such as Polyphenylene Sulfide (PPS), Nylon 66 (Polyamide, PA 66), PolyButylene Terephthalate (PBT), PolyPropylene (PP), PolyCarbonate (PC), Nylon 12 (Polyamide, PA 12), or Cross Linked PolyOlefin (XLPO).

In this example, the housing 82 of the header connector 70 are separate from the header base 62 and are secured to the header base 62 with a plurality of fasteners 94. In another example, the fasteners 94 can be omitted, and the header connector 70 and the header base 62 could be a single component that is molded together. That is, the header connectors 70 and the header base 62 could be parts of the same structure.

As the header base 62 is a polymer-based component, the header base 62 can be considered a dielectric. Accordingly, the header assembly 58 incorporates the grounding link 66 to establish a ground path between terminals 86 within the header connectors 70 and the enclosure assembly 34.

In this example, the grounding link 66 is made of a more conductive material than the header base 62. The grounding link 66 can be, for example, a metal or metal-alloy. In some examples, the grounding link 66 is copper, aluminum, or steel. Material selection for the grounding link 66 can be based at least in part on electromagnetic compatibility.

The example grounding link 66 includes a plurality of halos 100 and a plurality of legs 104. When assembled, each of the halos 100 circumscribes an aperture 108 within the header base 62. The header connectors 70 each span over one of the apertures 108 when connected to the header base 62. The header connectors 70 are connected to the header base 62 such that terminals 86 of that header connectors 70 contact the associated halo 100 of the grounding link 66.

The legs 104 each extend away from one of the halos 100 toward the enclosure assembly 34, here the enclosure tray 42.

Ends of the legs 104 include apertures 112. When the header base 62 is connected to the enclosure assembly 34, the fasteners 74 extend through one of the apertures 112. Thus, when the header base 62 is connected to the enclosure assembly 34 via the fasteners 74, portions of the legs 104 of the grounding link 66 are sandwiched between the header base 62 and the enclosure assembly 34.

Sandwiching portions of the legs 104 brings the legs 104 into direct contact with the enclosure assembly 34, which is a metal or metal alloy. Thus, after assembling the header assembly 58 to the enclosure assembly 34, the grounding link 66 establishes a ground path from terminals 86 within the header connectors 70 to the enclosure assembly 34, which is grounded to the underbody 26 of the vehicle 10.

Legs 104 can be added or removed depending on design considerations, such as the electromagnetic compatibility. The grounding link 66 provides sufficient routes to limit impedances and, generally, adding legs 104 decreases impedance of the grounding link 66. Impedance can be adjusted to mimic an impedance of a header assembly having an aluminum base.

The example grounding link 66 is coupled to the header base 62 via the fasteners 74. In other examples, the grounding link 66 could instead or addition be embedded within the header base 62.

While the grounding link 66 grounds the battery pack 14, the grounding link 66 could be used to ground other components in other examples.

Features of the disclosed examples include a header assembly having a base that is a dielectric. To establish a grounding path, a grounding link is contained within the header base. The grounding link is more conductive than the header base.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a header base of a header assembly, the header base connectable to a battery pack enclosure; and
a grounding link of the header assembly, the grounding link contained within the header base, the grounding link establishing a ground path between the battery pack enclosure and one or more vehicle connectors that are coupled to the header assembly.

2. The battery pack assembly of claim 1, wherein the header base is a dielectric.

3. The battery pack assembly of claim 1, wherein the header base is a polymer-based material.

4. The battery pack assembly of claim 1, wherein the grounding link is more conductive than the header base.

5. The battery pack assembly of claim 1, wherein the grounding link is a metal or metal alloy.

6. The battery pack assembly of claim 1, further comprising a plurality of mechanical fasteners that secure the header base to the battery pack enclosure.

7. The battery pack assembly of claim 6, wherein a portion of the grounding link is sandwiched between the battery pack enclosure and the header base.

8. The battery pack assembly of claim 1, wherein the battery pack enclosure includes a tray, the header base connectable to the tray.

9. The battery pack assembly of claim 8, wherein the tray is a metal or metal alloy.

10. The battery pack assembly of claim 1, wherein the header assembly includes a plurality of header connectors each having a header housing and at least one electrical terminal, the header connectors each configured to couple to one of the vehicle connectors.

11. The battery pack assembly of claim 10, wherein the header housings for the header connectors and the header base are separate components.

12. The battery pack assembly of claim 11, wherein the header base includes a plurality of apertures and the grounding link includes a plurality of halos, each halo within the plurality of halos circumscribing one of the apertures within the plurality of apertures, the header connectors each spanning over one of apertures within the plurality of apertures.

13. The battery pack assembly of claim 12, wherein the grounding link includes a plurality of legs each extending from one of the halos within the plurality of halos to the battery pack enclosure when the header base is connected to the battery pack enclosure.

14. The battery pack assembly of claim 13 wherein a plurality of mechanical fasteners secure the plurality of header connectors to the header base.

15. The battery pack assembly of claim 10, wherein the header housings for the header connectors and the header base are parts of the same structure.

16. The battery pack assembly of claim 1, further comprising,
the battery pack enclosure, and
a battery array held within an interior area of the battery pack enclosure.

17. A battery pack connection method, comprising:
securing a header base of a header assembly to a battery pack enclosure such that the header base is disposed over an opening in the battery pack enclosure and sandwiches a portion of a grounding link against the battery pack enclosure, the grounding link establishing a ground path between the battery pack enclosure and one or more vehicle connectors that are coupled to the header assembly.

18. The battery pack connection method of claim 17, further comprising securing the header base to the battery pack enclosure using at least one mechanical fastener.

19. The battery pack connection method of claim 17, further comprising securing a plurality of header connectors to the header base, each of the header connectors each having a header housing and at least one electrical terminal, the grounding link electrically coupled to the at least one electrical terminal.

20. The battery pack connection method of claim 19, further comprising coupling the one or more vehicle connectors to the header connectors to electrically couple a vehicle to the battery pack.
